(19) United States
(12) Patent Application Publication
(10) Pub. No.: US 2021/0235628 A1
(43) Pub. Date: Aug. 5, 2021

(54) PLANT GROWING TRAY SYSTEM

(71) Applicant: METHOD INNOVATION PARTNERS INC., Surrey (CA)

(72) Inventors: Carl PHILIBERT, Surrey (CA); Paraic Anthony PHELAN, Surrey (CA); Randall Clifford PLITT, Langley (CA); Greg John O'GORMAN, Vancouver (CA)

(21) Appl. No.: 17/166,629

(22) Filed: Feb. 3, 2021

Related U.S. Application Data
(60) Provisional application No. 62/969,445, filed on Feb. 3, 2020.

(30) Foreign Application Priority Data
Mar. 13, 2020 (CA) 3075576

(51) Int. Cl. A01G 9/02

(52) U.S. Cl. CPC A01G 9/02; A01G 2009/003

(57) ABSTRACT

A plant growing tray system, comprising a plurality of trays sequentially connected to each other via substantially impermeable inter-tray joints. Each of the plurality of trays extends between respective first and second lateral ends and has a respective plant growing space portion vertically recessed relative to respective first and second lateral ends in-between. Each inter-tray joint includes a male part positioned at a first horizontal longitudinal end of a tray and elongated between the respective first and second lateral ends of the tray, a female part complementary to the male part positioned at a second horizontal longitudinal end of an adjacent tray and elongated between the first and second lateral ends of the adjacent tray, and a substantially impermeable interstitial medium configured to be compressed between the male and female parts to generate residual stresses to at least partially support a tray load and mitigate leakage.

### CROSS REFERENCE TO RELATED APPLICATIONS

This application is a non-provisional of, and claims all benefit, including priority, to U.S. Application No. 62/969,445, dated Feb. 3, 2020, and Canadian Application No. 3,075,576, dated Mar. 13, 2020, both entitled PLANT GROWING TRAY SYSTEM and incorporated herein in their entirety by reference.

### FIELD

The application relates generally to a plant growing tray system.

### BACKGROUND

Plant growing trays are used to hold plants grown indoors or outdoors. These trays need to be able to hold soil and/or water or other nutrient fluid used to feed plants. There is a current propensity for plant growers to use a “clean room approach” to grow plants, often driven by regulation.

Current plant growing tray systems which can be assembled (e.g., modular) to fit a growing area are not leak-proof or explicitly designed to be so, require extensive and/or messy application of adhesives to prevent breakage/disassembly during usage, require bulky assembly components for connecting parts (e.g., couplers) that increase cost and complexity of assembly, or cannot be configured to provide a substantially continuous growing space (e.g., one without protrusions into the plant growing space). For example, in some systems adhesives and sealants may be used in combination to join multiple modules together and may not always be successful in preventing leaks. If leaks are detected, a complete disassembly, drying and reapplication of adhesives and sealants may be required. Additionally, using adhesives and sealants may make disassembly difficult, time-consuming and costly.

### SUMMARY

In one embodiment, there is provided a plant growing tray system. The plant growing tray system comprises a first tray, a second tray, and a substantially impermeable interstitial medium. The first tray includes a first horizontal lateral end, a second horizontal lateral end, a first horizontal longitudinal end, and a male part. The male part is positioned at the first horizontal longitudinal end and is elongated between the first and second lateral ends. The first tray extends between the first and second lateral ends. A portion between the first and second lateral ends of the first tray is vertically recessed relative to first and second lateral ends to form a first plant growing space. The second tray includes a third horizontal lateral end, a fourth horizontal lateral end, a second horizontal longitudinal end, and a female part. The female part is positioned at the second horizontal longitudinal end and is elongated between the third and fourth lateral ends. The female part is configured to complementarily couple with the male part. The second tray extends between the third and fourth lateral ends. A portion of the second tray between the third and fourth lateral ends is vertically recessed relative to third and fourth lateral ends to form a second plant growing space. The substantially impermeable interstitial medium is configured to at least partially extend around a circumferential surface of the male part to a fill a space between the male and female parts. The interstitial medium is configured to be compressed between the male and female parts to generate residual stresses to at least partially support a tray load and form a substantially impermeable inter-tray joint connecting the first tray to the second tray.

In another embodiment, a plant growing tray system. The plant growing tray system comprises a plurality of trays, including a first end tray, a second end tray, and a plurality of inter-tray joints. Each of the plurality of trays has a first lateral end and a second lateral end, horizontally extends between the respective first and second lateral ends, and has a portion between the respective first and second lateral ends vertically recessed relative to respective first and second lateral ends to form a plant growing space. The plurality of inter-tray joints are configured to sequentially connect the plurality of trays to each other. Each inter-tray joint includes a male part, a female part, and a substantially impermeable interstitial medium. The male part is positioned at a first horizontal longitudinal end of a tray and elongated between the respective first and second lateral ends of the tray. The female part is complementary to the male part. The female part is positioned at a second horizontal longitudinal end of an adjacent tray and elongated between the respective first and second lateral ends of the adjacent tray. The substantially impermeable interstitial medium is configured to be compressed between the male and female parts to generate residual stresses to at least partially support a tray load and form a substantially impermeable inter-tray joint connecting the tray to the adjacent tray. Each of the first and second end trays is configured to be connected to one of the plurality of trays.

In another embodiment, there is provided an intermediate tray module for a modular plant growing tray. The modular plant growing tray includes a plurality of tray modules configured to sequentially connect to each other via a plurality of inter-module joints. Each of the plurality of tray modules extends between first and second lateral ends and has a portion between the first and second lateral ends vertically recessed relative to first and second lateral ends to form a plant growing space. The plurality of tray modules include a first end module tray and a second end module tray. The intermediate tray module comprises a first horizontal lateral end, a second horizontal lateral end, a first horizontal longitudinal end, a second horizontal longitudinal end, a male part positioned at the first horizontal longitudinal end and elongated between the first and second lateral ends, and a female part positioned at the second horizontal longitudinal end and elongated between the first and second lateral ends. The male part is configured to complementarily engage with a female part of one of the plurality of tray modules via a first substantially impermeable interstitial medium. The female part is configured to complementarily engage with a male part of one of the plurality of tray modules via a second substantially impermeable interstitial medium. The intermediate tray module extends between the first and second lateral ends. A portion between the first and second lateral ends of the intermediate tray module is vertically recessed relative to first and second lateral ends to form a plant growing space of the intermediate tray module. The first interstitial medium is configured to be compressed to form a first substantially impermeable inter-tray joint, and the second interstitial medium is configured to be compressed to form a second substantially impermeable inter-module joint. The first and second inter-module joints are configured to at least partially support a tray load.

In another embodiment, there is provided a method of joining a first tray and a second tray of a plant growing tray system. The first and second trays each have a (vertically recessed) plant growing receptacle with a longitudinally open end. The plant growing receptacle is vertically recessed relative to first and second lateral ends. The first tray includes a male part laterally elongated along an edge of the open end of the plant growing receptacle of the first tray. The second tray includes a female part laterally elongated along an edge of the open end of the plant growing receptacle of the second tray. The method comprises receiving the male part inside the female part including disposing an interstitial medium between the male and female parts to fill a space between male and female parts, and generating residual stresses in the interstitial medium via compression of the interstitial medium between the male and female parts to at least partially support a tray load and form an impermeable inter-tray joint connecting the first tray to the second tray, while the interstitial medium is disposed between the male and female parts.

In another embodiment, there is provided a method of forming a substantially continuous plant growing space. The method comprises receiving a male part elongated along an edge of a first tray inside a female part elongated along an edge of a second tray including disposing an interstitial medium between the male and female parts to fill a space between male and female parts, and generating residual stresses in the interstitial medium via compression of the interstitial medium between the male and female parts to form an impermeable inter-tray joint hindering disconnection of the first tray from the second tray, while the interstitial medium is disposed between the male and female parts.

In another embodiment, there is provided a plant growing tray system. The plant growing tray system comprises a first tray defining a first plant growing space extending between at least two ends, a second tray defining a second plant growing space extending between at least two ends, and an impermeable joint connecting the first and second trays via a compressed medium elongated between the ends of the first and second plant growing spaces. The compressed medium is configured to generate residual stresses to support a tray load.

In another embodiment, there is provided a method of joining a first tray and a second tray. The first tray defines a first plant growing space and the second tray defines a second plant growing space. The method comprises engaging a portion of the first tray with a complementary portion of the second tray to form an at least partially closed space elongated across and between the plant growing spaces, disposing an interstitial medium in the at least partially closed space, and generating residual stresses in the interstitial medium via compression against surfaces of the at least partially closed space to support a tray load and prevent leakage while the interstitial medium is disposed in the at least partially closed space.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE DRAWINGS

Embodiments will be described, by way of example only, with reference to the attached figures, wherein in the figures:

FIG. 1A is a top plan view of an example of a plant growing tray system, in accordance with some embodiments;

FIG. 1B is a side elevation view of the example of the plant growing tray system, in accordance with some embodiments;

FIG. 1C is a front elevation view of the plant growing tray system, in accordance with some embodiments;

FIG. 2 is an enlarged view focused on region C of FIG. 1A of the plant growing tray system showing the inter-tray joint between the first tray and the second tray, and between a horizontal longitudinal end of the first tray and a horizontal longitudinal end of the second tray, in accordance with some embodiments;

FIG. 3 is a sectional view taken along cross-section lines A-A′ of FIG. 1A of the plant growing tray system, in accordance with some embodiments;

FIG. 4 is an enlarged view focused on region D of FIG. 3 of the plant growing tray system, and showing the inter-tray joint, in accordance with some embodiments;

FIG. 5 is a perspective view of the plant growing tray system, in accordance with some embodiments;

FIG. 6A is an enlarged view focused on region E′ of FIG. 5 of the plant growing tray system, in accordance with some embodiments;

FIG. 6B is an enlarged view focused on region E of FIG. 5 of the plant growing tray system, in accordance with some embodiments;

FIG. 7 is an exploded view of the plant growing tray system, in accordance with some embodiments;

FIG. 8A is an enlarged view focused on region F of FIG. 7 of the plant growing tray system, in accordance with some embodiments;

FIG. 8B is an enlarged view focused on region F′ of FIG. 7 of the plant growing tray system, in accordance with some embodiments;

FIG. 8C is an enlarged view focused on region F″ of FIG. 7 of the plant growing tray system, in accordance with some embodiments;

FIG. 9 is an enlarged sectional view taken along cross-section lines A-A′ of FIG. 1A of the plant growing tray system focused on an inter-tray joint, in accordance with some embodiments;

FIG. 10A is a perspective view of a plant growing tray system, in accordance with some embodiments;

FIG. 10B is another perspective view of a plant growing tray system, in accordance with some embodiments;

FIG. 10C is a schematic perspective view of a plant growing tray system, in accordance with some embodiments;

FIG. 11 is a schematic sectional view taken along horizontal longitudinal lines of a plant growing tray system, in accordance with some embodiments;

FIG. 12 is a flow chart of a method of joining a first tray and a second tray of a plant growing tray system, in accordance with some embodiments;

FIG. 13 is a flow chart of a method of forming a substantially continuous or uninterrupted plant growing space, in accordance with some embodiments;

FIG. 14 is a flow chart of a method of joining a first tray and a second tray, in accordance with some embodiments;

FIG. 15 is a perspective view of a plant growing tray system atop a support system, in accordance with some embodiments;

FIG. 16 is another perspective view of the plant growing system of FIG. 15 atop a support system, in accordance with some embodiments; and

FIGS. 17A to 17G illustrate an example of an intermediary plant growing tray, in accordance with some embodiments.

It is understood that throughout the description and figures, like features are identified by like reference numerals.

### DETAILED DESCRIPTION

Embodiments of methods, systems, and apparatus are described through reference to the drawings.

Plant growing trays, especially for indoor applications, may need to be of varying sizes depending on the size of the growing room. Plant growing trays should be able to hold the weight of plants and any accompanying material such as soil/nutrients/water. In indoor applications, any additional structures added to support the weight of plants in plant growing trays reduces the space available for growing plants, especially in “high-density indoor agriculture” motivated by reducing energy consumption. Leakage from plant growing trays may increase energy consumption and cost of growing plants by increasing irrigation needs. Plant nutrients are usually expensive and may be provided in the irrigation feed or otherwise supplied to the plants, e.g., by mixing with soil. Leakage in plant growing trays may substantially increase costs associated with a plant growing operation due to direct leakage of nutrient or premature flushing of nutrients from the plant growing tray because of frequent irrigation. Additionally, when trays are stacked, tray leakage may cause cross-contamination between different plants, which may have different irrigation (water, nutrients, etc.) requirements. When plants are grown indoor, leakage may lead to undesirable mould growth. Leak-proof behaviour is important, especially for indoor applications (0% leak tolerance or substantially 0% leak tolerance), and in certain applications of hydroponics where the soil is flooded first for maximum wettability and then drained. In some embodiments described herein, the term “leak-proof” may include the terms “leak-resistant” or substantially “leak-proof”. Moreover, in some embodiments described herein, preventing leakage may include substantially preventing leakage or mitigating leakage.

In some embodiments, a modular tray system is provided where modular trays are connected via a gasket channel. The gasket is compressed in the channel when installed, providing a substantially water-tight seal. The channel may open slightly and a flange or overlap will flex away from the tray. When the tray is supported with a cross-member underneath the gasket channel, this further compresses the gasket for a better seal. Further details and embodiments are described below.

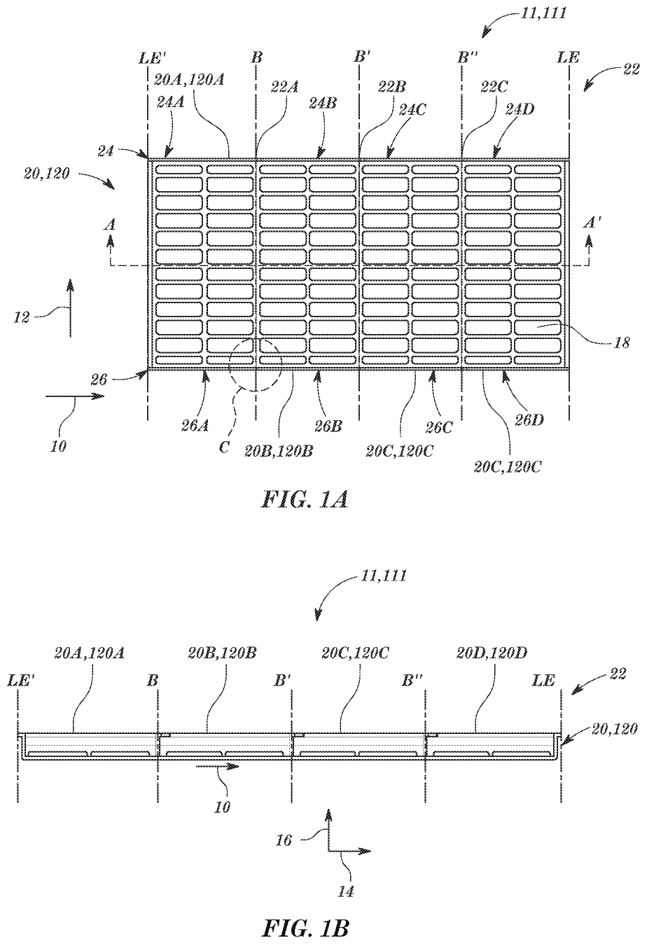

Referring now to the drawings, FIG. 1A is a top plan view of an example of a plant growing tray system 11, in accordance with some embodiments, FIG. 1B is a side elevation view of the plant growing tray system 11, and FIG. 1C is a front elevation view of the plant growing tray system 11.

In reference to FIGS. 1A to 1C, the plant growing tray system 11 comprises a plurality of trays 20 (individually numbered 20A, 20B, 20C, 20D) and a plurality of inter-tray joints 22 (individually numbered 22A, 22B, 22C) configured to sequentially connect the plurality of trays 20 to each other. The plant growing tray system 11 includes a first tray 20B and a second tray 20A. The second tray 20A may be a first end tray. Another tray 20D may be a second end tray. The locations of inter-tray joints are marked in FIGS. 1A and 1B by broken dashed lines labeled B, B′, and B″. The inter-tray joints 22 may be substantially impermeable and configured to at least partially support a tray load. The inter-tray joints 22 may be sufficiently impermeable to prevent or mitigate water leakage from the plant growing tray system 11.

In some embodiments, the plant growing tray system 11 is a modular plant growing tray 111 and the plurality of trays 20 are tray modules trays 120. The modular plant growing tray 111 may be configured to be expandable (by adding additional tray modules) or assembled or disassembled by a user (e.g., an end user). I.e., a plant growing tray system 11 may include two end trays with zero or more middle trays.

The plant growing tray system 11 may define a vertical direction 16 perpendicular to a tray opening (e.g., defined by a plane with a perpendicular in a vertical direction) opposed to a bottom surface 18 of the tray. In some embodiments, the tray is oriented during use so that the vertical direction 16 is parallel to a direction of gravity. The horizontal direction 14 may be substantially perpendicular to the vertical direction. The plan view of FIG. 1A is in a plane parallel to the horizontal direction 14. A plane parallel to the horizontal direction 14 defines a longitudinal direction 10 and a lateral direction 12. The longitudinal direction 10 may define the direction of sequential arrangement of the plurality of (inter-connected) trays 20, which may or may not be the same everywhere in the plant growing tray system. For example, in a circular (or circularly extending) plant growing tray system, the longitudinal direction 10 may be the same or substantially the same as the direction implied by an angular direction of movement along the plant growing tray system—such as may be defined by a radial coordinate system centred at a point equidistant from points on an inner edge of the circular plant growing tray system. A circular plant growing tray system may allow plants to be grown contiguously to each other, since one may repeatedly reach the same point on the tray system by longitudinally traversing the circular plant growing space continuously. In some embodiments, the plant growing tray system is a modular tray system 120 configured to be expandable in the longitudinal direction 10. The lateral direction 12 may be perpendicular to the longitudinal direction 10. The lateral direction 12 may define (or, in some cases, may be defined by) a width of a plant growing space 32, e.g., a width along which plants may be placed for growing on the tray system. The lateral direction 12 may define a direction along which inter-tray joints 22 connect a tray and an adjacent tray, e.g., tray 20A and adjacent tray 20B.

Broken dashed lines labeled LE′, B, B′, B″, LE in FIGS. 1A and 1B indicate ends of the plurality of trays 20 in the longitudinal direction 10. The plurality of trays 20 each have ends in a lateral direction 12; each of the plurality of trays 20 has a first lateral end 24 and a second lateral end 26. Each tray horizontally extends between the first and second lateral ends 24, 26 and has a portion vertically recessed between the first and second lateral ends 24, 26 to form a plant growing space (seen in the plan view of FIG. 1A).

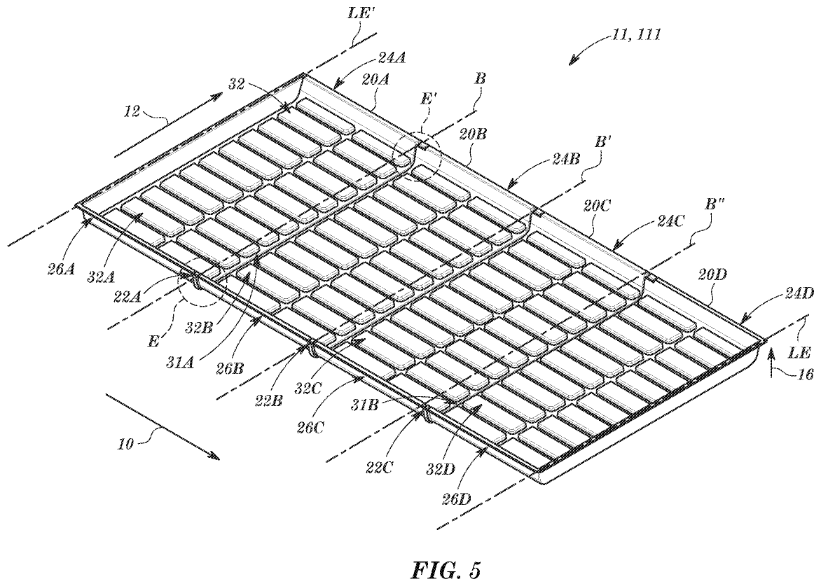

The first tray 20B includes a first horizontal lateral end 24B, a second horizontal lateral end 26B, and a horizontal longitudinal end (e.g., located at the inter-joint line B). The horizontal longitudinal end of the first tray 20B may sometimes be labelled or referred to as a first horizontal longitudinal end. The second tray 20A includes a first horizontal lateral end 24A, a second horizontal lateral end 26A, and a horizontal longitudinal end (located at the inter-joint line B and not shown). The first horizontal lateral end 24A, second horizontal lateral end 26A and horizontal longitudinal end of the second tray 20A may sometimes be labelled or referred to as the third horizontal lateral end 24A, fourth horizontal lateral end 26A and second horizontal longitudinal end, respectively. The first tray 20B extends between the first and second lateral ends 24B, 26B. The second tray 20A extends between the first and second lateral ends 24A, 26A. Each of the plurality of trays extends between its respective first (24A, 24B and 24C, 24D shown in FIG. 5) and second lateral ends (26A, 26B and 26C, 26D shown in FIG. 5).

The trays 20B, 20C may be intermediate trays or (intermediate) modular trays 120B, 120C which may be augmented by additional modular trays to expand the modular plant growing tray 111 by forming additional inter-tray joints. Accordingly, inter-tray joint 22B may be an intermediate inter-tray joint. Additional intermediate trays may introduce additional intermediate inter-tray joints in the plant growing tray system 11. I.e., zero or more intermediate (i.e., middle) trays may be added to the plant growing tray system 11.

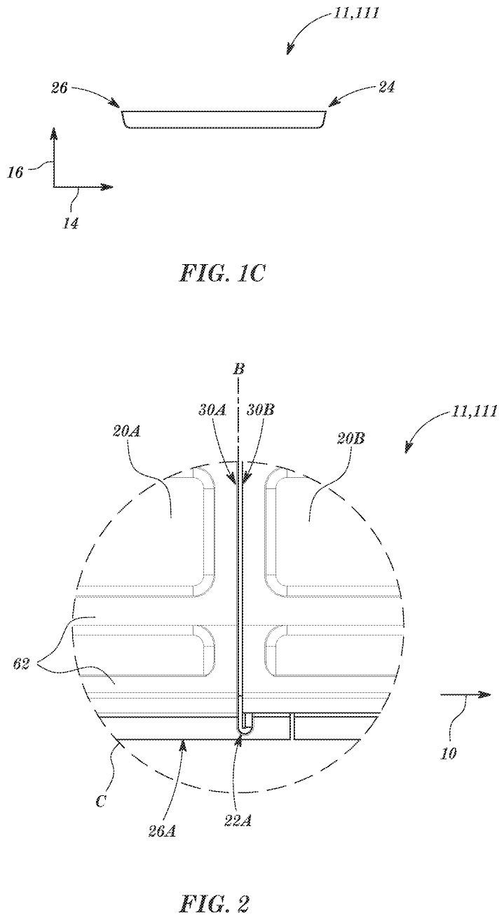

FIG. 2 is an enlarged view focused on region C of FIG. 1A of the plant growing tray system 11 showing the inter-tray joint 22A between the first tray 20B and the second tray 20A, and between a horizontal longitudinal end 30B of the first tray 20B and a horizontal longitudinal end 30A of the second tray 20A, in accordance with some embodiments. The plant growing tray system 11 may include a plurality of irrigation channels 62, e.g., grooves in the tray surface to convey irrigating fluid to plants in the trays. Having a substantially continuous leak proof (or leak resistant) connection of the plurality of trays 20 via inter-tray joints 22 ensures an efficient conveyance of irrigating fluid, e.g., without obstructions and without structures that may reduce flow efficiency of the irrigating fluid.

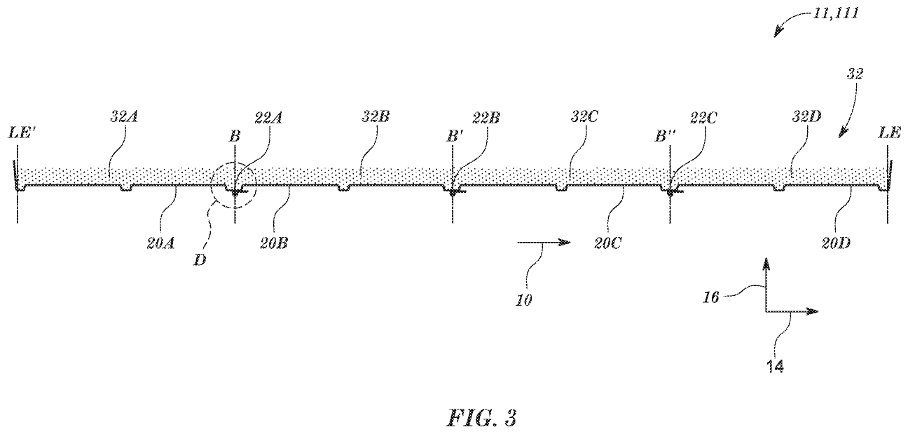

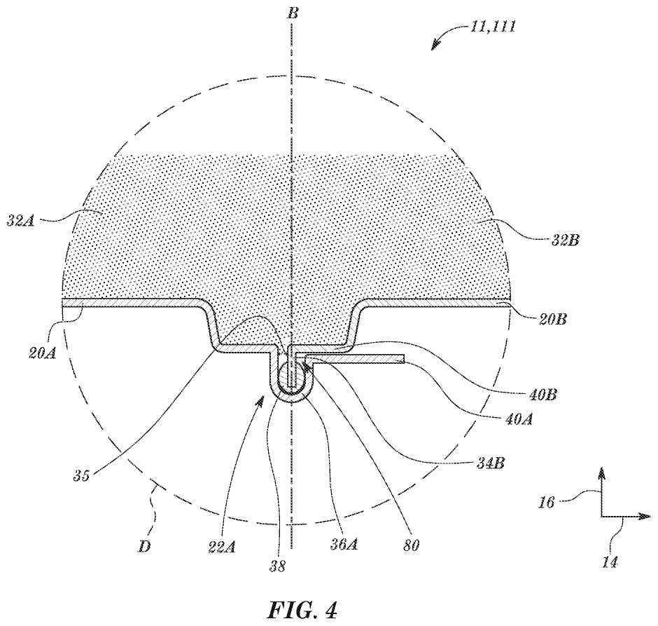

FIG. 3 is a sectional view taken along cross-section lines A-A′ of FIG. 1A of the plant growing tray system 11, in accordance with some embodiments. The sectional view shows the inter-tray joint 22A connecting the first tray 20B and the second tray 20A, the inter-tray joint 22B connecting the first tray 20B and the tray 20C, and the inter-tray joint 22C connecting the second tray 20C and the tray 20D. A portion of the first tray 20B is vertically recessed between the first and second lateral ends 24B, 26B to form a (first) plant growing space 32B (for containing or supporting a tray load which may be soil, as shown in the dotted hatch pattern of FIG. 3). Similarly, a portion of the second tray 20A is vertically recessed between the first and second lateral ends 24A, 26A (and relative to first and second lateral ends) to form a (second) plant growing space 32A (where the second tray 20A defines the plant growing space 32A). The trays 20C and 20D define plant growing spaces 32C and 32D, respectively.

The inter-tray joints 22A, 22B, 22C connect the plant growing spaces 32A, 32B, 32C, 32D to define a substantially continuous or uninterrupted plant growing space 32 (containing or supporting a tray load which may be soil, as shown in the dotted hatch pattern of FIG. 3).

FIG. 4 is an enlarged view focused on region D of FIG. 3 of the plant growing tray system 11, and showing the inter-tray joint 22A, in accordance with some embodiments. The first tray 20B includes a male part 34B positioned at the horizontal longitudinal end 30B and elongated between the first and second lateral ends 24B, 26B. The second tray 20A includes a female part 36A positioned at the horizontal longitudinal end 30A and elongated between the first and second lateral ends 24A, 26A. The female part 36A is configured to complementarily couple or engage with the male part 34B. Such a coupling or engagement leads to the formation of a partially closed space 80 or void, e.g., that can be filled by a waterproof and weight supporting material to form a substantially (or close to) gapless connection between the trays 20A and 20B. The female part 36A may couple with the male 34B by frictional engagement. For example, the female part 36A may couple with the male part 34B by an interference fit (snap fit) between the male part 34B and the female part 36A. In some embodiments, an interference fit may be facilitated by an end, or circumference or circumferential surface of (an end) of the male part 34B being larger than the internal receptacle of the female part 36A configured to the receive the (end of the) male part 34B.

An interference fit between the male part 34B and female 36A may be facilitated by an interstitial medium 38 (or simply medium 38) between the male part 34B and female part 36A. The interstitial medium 38 may be configured to be compressed and retain (an end of) the male part 34B inside (a receptacle of) the female part 36A via frictional engagement. The frictional engagement may be caused or facilitated by a stress or force exerted by the interstitial medium 38 on internal walls of the female part 36A. A substantially impermeable interstitial medium 38 may be configured to extend at least partially around a circumferential surface of the male part 34B to fill a space 35 between male and female parts. The space 35 may be exposed to the plant growing space 32 so that if the space 35 is not filled or otherwise blocked, leakage (of water or other fluid(s)) from the tray may occur via the space 35. The circumference may be such that, when the male part 34B couples with the female part 36A, the interstitial medium substantially fills a gap between the male and female parts to prevent leakage from the tray via the inter-tray joint and generate stress via application of forces (or stresses) at the ends of the gap so filled. The interstitial medium 38 may be a gasket. The interstitial medium 38 may be a sealant. In some embodiments, the interstitial medium 38 in the inter-tray joint 22A may be an adhesive or include an adhesive such the inter-tray joint 22A remains leak-proof (or leak resistant). In some embodiments, the interstitial medium 38 may be silicone. In some embodiments, the interstitial medium 38 may be a combination of a gasket and an adhesive sealant. In some embodiments, the interstitial medium 38 is an elastomer. In some embodiments, the interstitial medium 38 is neoprene. The interstitial medium 38 may extend around the male part 34B so as to fill a space between the male and female parts 34B, 36A. In some embodiments, the interstitial medium 38 is removably attached to the male part 34B and/or the female part 36A, irremovably attached (fixedly attached, e.g., using adhesive) to the male part 34B and/or the female part 36A, or integral with the male part 34B and/or the female part 36A. In some embodiments, the interstitial medium 38 comprises a plurality of distinct elements (e.g., an element attached to the female part and an element attached to the male part) combined to function together as an interstitial medium 38 providing the means for frictional engagement of the male part 34B with the female part 36A. In some embodiments, the interstitial medium 38 may be provided in non-solid forms such as liquid, granular (a medium composed of a plurality of individual solid elements or granules which may behave fluid-like), or other fluid or fluid-like forms. In some embodiments, a non-solid form of the interstitial medium 38 is treated (e.g., by curing including after mixing with other additives and solvents) to form an elastic solid material. Such an elastic solid material may be advantageous as it may be configured to conform to a shape of the male part 34B and/or female part 36A. In some embodiments, the interstitial medium 38 surrounds the male part 34B, e.g., by completely surrounding the male part 34B. The interstitial medium 38 is configured to be compressed between the male and female parts 34B, 36A to generate residual stresses. The residual stresses may be the difference between an ambient or hydrostatic pressure at the inter-tray joint 22A and a material stress in the interstitial medium 38. The residual stresses may be the net stress exerted by the interstitial medium 38 on the internal surfaces of the female part 36A. The residual stresses may at least partially support a tray load, e.g., soil, and form a substantially impermeable inter-tray joint connecting a tray to the adjacent tray, e.g., the first tray to the second tray. The residual stresses may be normal stresses. The residual stresses may cause or facilitate frictional engagement to retain the connection between the male part 34B and female part 36A, including under a tray load, and to prevent leakage from the plant growing tray system 11 (or 111).

In some embodiments, the first horizontal longitudinal end 30B of the first tray 20B is positioned at an extremity of the first tray 20B. In some embodiments, the first horizontal longitudinal end 30A of the second tray 20A is positioned at an extremity of the second tray 20A. In some embodiments, The first tray 20B includes an overlap section 40B extending horizontal longitudinally at the first horizontal longitudinal end 30B of the first tray 20B. In some embodiments, the second tray 20A includes an overlap section 40A extending horizontal longitudinally at the first horizontal longitudinal end 30A of the second tray 20A.

In some embodiments, the male and female parts 34B, 36A are configured to connect along a vertical direction 16. This may prevent the inter-tray joint 22A from protruding into a plant growing space 32 of the plant growing tray system 11. In some embodiments, the male part 34B is positioned vertically below the first plant growing space 32B and/or the female part 36A is positioned vertically below the second plant growing space 32A. In some embodiments, the male part 34B extends vertically below the first plant growing space 32B and/or the female part 36A extends vertically below the second plant growing space 32A. In some embodiments, the inter-tray joint 22A is positioned outside the plant growing space 32. In some embodiments, the male and female parts 34B, 36A are configured to connect along a horizontal direction 14. In some embodiments, the male and female parts 34B, 36A are configured to connect along a direction intermediate between horizontal and vertical directions 14, 16, e.g., at a 45° angle.

In some embodiments, the male part 34B is an integral part of the first tray 20B and the female part 36A is an integral part of the second tray 20A. In some embodiments having a plurality of trays connected sequentially via inter-tray joints, each male part of an inter-tray joint is integral to a tray, each female part is integral to a tray, and each intermediate tray has both a male and female part. In some embodiments, the male part 34B may not be an integral part of the first tray 20B and/or the female part 36A may not be an integral part of the second tray 20A. For example, in some embodiments, the male part 34B and/or female part 36A may be manufactured separated. In some embodiments, a separately manufactured male part 34B (or, respectively, a female part 36A) may be removably or irremovably attached to the tray 20B to facilitate the male part 34B (or, respectively, the female part 36A) to couple with the female part 36A (or, respectively, the male part 34B). For example, in some embodiments, the tray 20B (or, respectively, the tray 20A) and the male part 34B (or, respectively, the female part 36A) may be attached to each other via plastic welding, adhesives, clasps, mechanical fasteners, or an interference fit configured to retain a connection between the tray 20B (or, respectively, the tray 20A) and the male part 34B (or, respectively, the female part 36A) by frictional engagement. In some embodiments, the inter-tray joint 22A includes adhesive. In some embodiments, the inter-tray joint 22A is configured so that the first tray 20B is removably attached to the second tray 20A under application of sufficient force, e.g., to deform the interstitial medium 38 to allow insertion and retention (by coupling or other engagement) of the male part 34B inside the female part 36A. For example, in some such embodiments, the inter-tray joints 22 are inter-module joints connecting tray modules of a modular plant growing tray.

FIG. 5 is a perspective view of the plant growing tray system 11, in accordance with some embodiments.

The plant growing tray system may include a plurality of trays 20A-D. Each of the plurality of trays 20A-D may have a respective first lateral end 24A-D and second lateral end 26A-D. Each of the plurality of trays 20A-D (horizontally) extends between the first and second lateral ends 24A-D, 26A-D and has a portion vertically recessed between the first and second lateral ends 24A-D, 26A-D (and relative to first and second lateral ends 24A-D, 26A-D) to form a plant growing space 32. The plurality of inter-tray joints 22A-C are configured to sequentially connect the plurality of trays 20A-D to each other. In some embodiments, the inter-tray joint 22A is positioned outside of the first and second plant growing spaces 32B, 32A to form a substantially continuous or uninterrupted plant growing space 32 by connecting the first plant growing space 32B to the second plant growing space 32A. The plurality of trays 20A-D include one or more intermediate trays 20B-C, each intermediate tray may be configured to be sequentially connected to two of the plurality of trays, e.g., tray 20B may be configured to connect to tray 20A on longitudinal end and tray 20C on another longitudinal end. The inter-tray joints 22A-C may be configured to sequentially connect the plant growing spaces 32A-D of the plurality of trays 20A-D form a substantially continuous or uninterrupted plant growing space 32. The first and second lateral ends 24B, 26B of the first tray 20B may be positioned at extremities of the first tray 20B. The first and second lateral ends 24A, 26A of the second tray 20A are positioned at extremities of the second tray 20A. The extremities of the first tray 20B and/or the second tray 20A may be in a lateral direction 12.

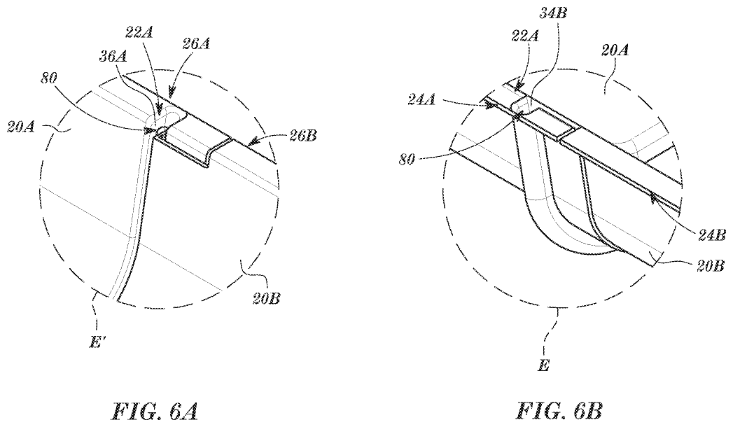

FIG. 6A is an enlarged view focused on region E′ of FIG. 5 of the plant growing tray system 11, in accordance with some embodiments.

FIG. 6B is an enlarged view focused on region E of FIG. 5 of the plant growing tray system 11, in accordance with some embodiments.

In reference to FIGS. 6A and 6B, the female part 36A may include a cavity formed in the bottom surface 18 of the second tray 20A. The cavity may be recessed within a body of the second tray 20A and extend across the second tray 20A from the first lateral end 24A to the second lateral end 24B.

Inter-tray joint 22A may be configured to substantially not produce a protrusion into a plant growing space 32 of the plant growing tray system 11 but rather may produce a protrusion outside of the plant growing tray system 11.

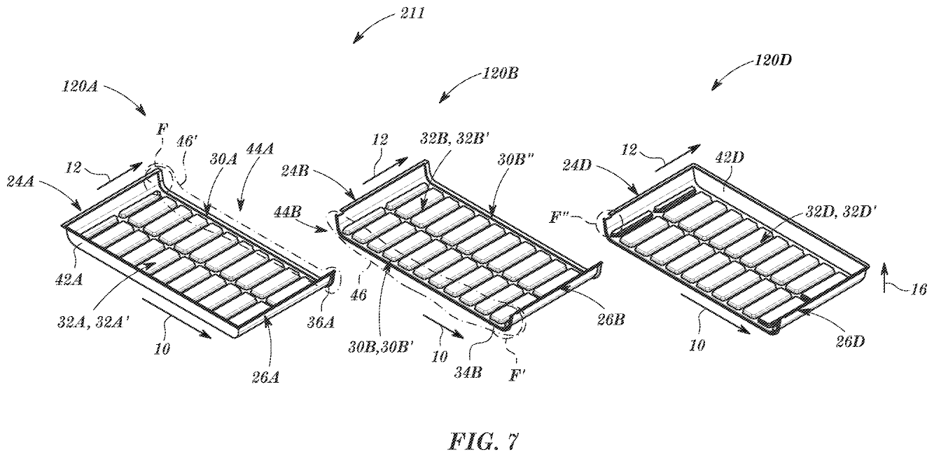

FIG. 7 is an exploded view of the plant growing tray system 11, in accordance with some embodiments. The plant growing tray system may be a modular plant growing tray 211. The modular plant growing tray 211 comprises a plurality of trays or tray modules which may be removably connected to each other via inter-module joints or inter-tray joints. Inter-module joints may be substantially the same as inter-tray joints. The plant growing tray system 211 comprises tray modules 120A, 120B, 120D, including an intermediate tray module 120B which may be selectively installed in the plant growing tray system 211. The plant growing tray system 211 may be augmented further by adding additional intermediate tray modules. When the intermediate tray module 120B is removed, the play growing tray system 211 only comprises first end module tray 120A and a second end module tray 120D, which may be (e.g., first and second) end trays of the plant growing tray system 211 or another embodiment. The trays 120A and 120D may be end trays. Each of trays 120A, 120D of the modular growing tray system may include a sidewall 42A, 42D defining a closed longitudinal end (see longitudinal ends LE and LE′ in FIGS. 1A and 1B).

In some embodiments, the tray modules 120A-D may be similar to trays 20A-D, e.g., inter-tray joints connecting the tray modules 120A-D may be similar to inter-tray joints connecting trays 20A-D. In some embodiments, tray modules 120A-D may be different than trays 20A-D in that they may allow the modular plant growing tray 211 to be flexibly assembled or re-assembled to different sizes, e.g., by adding or removing additional trays via removable (reconfigurable) inter-tray joints, whereas in some embodiments trays 20A-D may be provided by a manufacturer in a fixed size with or without irremovable (affixed) inter-tray joints. Thus, in aspects of this disclosure modular plant growing trays 211 (or 111) are distinguished from plant growing tray systems 11 in that modular plant growing trays 211 (or 111) may necessarily facilitate configurability (or re-configurability) during manufacturing and/or by an end user.

The first and second tray modules 120B, 120A may include an end tray (e.g., tray 120A) and an intermediate tray 120B of the plant growing tray system 211. The plant growing tray system then includes an additional end tray (e.g., tray 120D) configured to be connected via an additional inter-tray joint to another tray module of the modular tray, e.g. intermediate trays 120B or 120C.

In some embodiments, the modular plant growing tray 211 comprises end trays (similar to trays 120A, 120D) and a plurality of additional intermediate trays similar to intermediate tray 120B sequentially connected via a plurality of intermediate inter-tray joints. A tray (e.g., 20A or 120A), which may be an end tray, may be configured to be connected to a first longitudinal end 31A of the plurality of additional intermediate trays via an inter-tray joint. An additional tray (e.g., 20D or 120D), which may be an end tray, may be configured to be connected to a second longitudinal end 31B of the plurality of additional intermediate trays via an additional inter-tray joint (see FIG. 5). In some embodiments, there are no additional intermediate trays and one end tray (e.g., tray 20A or 120A) may be configured to connect directly to the additional tray (e.g., tray 20D or 120D) via inter-tray joints.

The modular plant growing tray 211 includes an intermediate tray module 1206, including a first horizontal lateral end 24B, a second horizontal lateral end 26B, a first horizontal longitudinal end 30B′, a second horizontal longitudinal end 30B″.

The modular trays 120A, 1206, 120D may include each include a plant growing receptacle 32A′, 32B′, 32D′ defining the plant growing spaces 32A, 32B, 32D. Inter-tray joints may extend completely along a perimeter of a cross-section of the plant growing receptacles 32A′, 32B′, 32D′ parallel to the open ends of the plant growing receptacles. For example, the open end 44A of second tray 120A may be configured to connect the plant growing space 32A to the plant growing space 32B.

The first tray 1206 includes a male part 34B laterally elongated along an edge 46 of the open end 44B of the plant growing receptacle 32B′ of the first tray 120B. The second tray 120A includes a female part 36A laterally elongated along an edge 46′ of the open end 44A of the plant growing space 32A of the second tray 120A.

The male part 34B continuously extends between the first and second lateral ends 24B, 26B of the first tray 1206. The female part 36A continuously extends between the first and second lateral ends 24A, 26A of the second tray 120A.

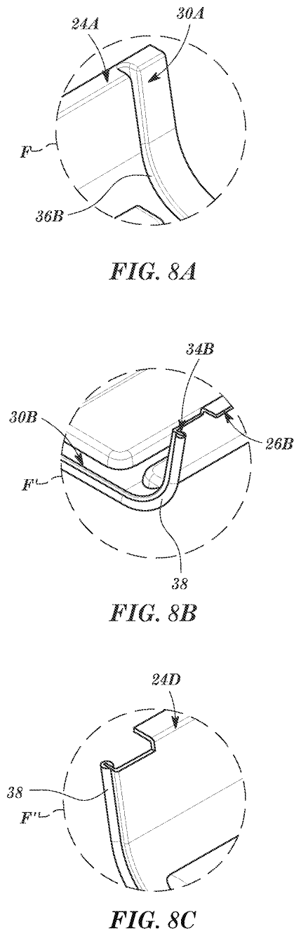

FIG. 8A is an enlarged view focused on region F of FIG. 7 of the plant growing tray system 11, in accordance with some embodiments.

FIG. 8B is an enlarged view focused on region F′ of FIG. 7 of the plant growing tray system 11, in accordance with some embodiments.

FIG. 8C is an enlarged view focused on region F″ of FIG. 7 of the plant growing tray system 11, in accordance with some embodiments.

In reference to FIGS. 8A-8C, the interstitial medium 38 may be fixedly or removable attached to the first tray 1206 or tray 120D (which may be an end tray). The male part 34B may be positioned at the first horizontal longitudinal end 30B and elongated between the first and second lateral ends 24B, 26B. The male part 34B may be configured to complementarily engage with a female part 36B of one of the plurality of tray modules via a first substantially impermeable interstitial medium 38.

Prior to use, the plant growing tray system 11 is assembled by joining the plurality of trays 20 to each other via the inter-tray joints 22.

The inter-tray joints 22 may be of simplified construction where, in some embodiments, the male/female parts 34B, 36A of the inter-tray joint 22 are integrated with the trays 20 and otherwise only have an additional interstitial medium 38 disposed in-between for load support and providing additional leak-proofing. The simplified construction may lower manufacturing cost, enable faster assembly/disassembly, reduce costs by reducing material needs and shipping and strategically minimizes the chance of leakage—either by mechanical failure or flawed design—by minimizing the number of parts/joints where a failure (leakage) may occur, e.g., the inter-tray joint 22 may extend beyond a region where water (liquid) or moisture is likely to be present (a plant growing space) so that no leakage may occur at the ends of the inter-tray joint 22A so extended. In prior art systems, leak-proofing came at significant additional cost or inconvenience, e.g., of extra leak-proofing components, specialized leak-proofing paints or coatings, extensive and difficult application of specialized adhesives, etc.

The interstitial medium 38 at least partially covers a circumferential surface of the male part 34B as it engages a complementary circumference of the female part 36A to prevent leakage into the female part 36A below the interstitial medium 38.

In some embodiments, the design of the inter-tray joints 22 (male/female parts) ensures ease and low cost manufacturing (e.g., plastic injection molding). In some embodiments, the inter-tray joints 22 are designed to take advantage of gravity. By connecting the male and female parts 34B. 36A in a vertical direction 16 and positioning the inter-tray joint 22 below the plant growing space 32, the weight of the tray (and tray load, e.g., water) provides a downward force on the male part 34B engaged with the female part 36A. As a result, the interstitial medium is further compressed to improve leak-proofing.

In general, the inter-tray joint 22 may be said to be substantially impermeable to prevent leakage. Substantial impermeability may be expressed in terms of residual stresses: proportional to a difference between the fluid pressure at the inter-tray joint 22 and stress exerted by the interstitial medium 38 on internal surfaces of the female part 36A. If fluid pressure (e.g., hydrostatic pressure in the case of stationary fluid) is sufficiently high in the plant growing space 32 adjacent to the inter-tray joint 22, fluid in contact with the inter-tray joint 22 may leak either through the interstitial medium 38 or may intervene between the interstitial medium 38 and internal surfaces of the female part 36A, e.g., via micro-gaps on the surface of the female part 36A that are left unfilled by deformed interstitial medium 38. Thus, the interstitial medium's size (dimensions before and after compression), stiffness and inherent permeability (i.e., material permeability) may be adjusted to match the application. For example, in certain applications the plant growing space 32 may be vertically large (tall) and hold nutrient-rich water without (aerated) soil. In this situation, the hydrostatic pressure at the inter-tray joint may be larger than for a shallow drainage plant and thus, may require a stiffer and more impermeable material and/or filling a smaller gap between male and female parts 34B, 36A to cause a more impermeable inter-tray joint 22 once assembled.

In some embodiments, the interstitial medium 38 significantly contributes to the load carrying capacity of the inter-tray joint 22. In some embodiments, the interstitial medium 38 may be described as a gasket having relatively less load carrying capacity. Residual stresses sustained by the interstitial medium 38 influence the weight carrying capacity of the plant growing tray system 11. While in some embodiments, the inter-tray joint 22 is strong enough to sustain the weight of a tray load on the plant growing tray system 11, in some embodiments the plant growing tray system 11 may need additional structural frame(s). However, in either case, the ability of the inter-tray joint 22 to carry a load may ensure that the plant growing tray system 11 does not disassemble during movement or rearrangement.

Extending the inter-tray joint 22 continuously between lateral ends defining a portion of the tray used for plant growing, rather than having discrete inter-tray joints not extended as such, ensures leak free design and a structurally stronger plant growing tray system 11. In some embodiments, adhesive may be used in the inter-tray joint 22 to augment the inter-tray joint's 22 strength and impermeability, e.g., by providing a more secure assembly or mitigation in case of failure. In some embodiments, the continuous inter-tray joint 22 facilitates application of adhesives and/or an interstitial medium 38 applied first and caused to set to a substantially impermeable interstitial medium 38.

In some embodiments, the inter-tray joints 22 are designed to hang below the plant growing tray system 11 and thereby not protrude into the plant growing tray system 11. In some embodiments, the inter-tray joint 22 is configured to provide a substantially continuous, uninterrupted or “seamless” plant growing space 32 (non-intrusive design), e.g., by positioning the inter-tray joint 22 below the plant growing space 32 or inside irrigation channels 62 where they may not interfere with the main plant growing space 32. Providing such seamless assembly may maximize space available for plant growing and may enable continuous irrigation and thereby significantly reduce costs.

In some embodiments, the inter-tray joint 22 may be an adhesive-free joint. In such embodiments, the plant growing tray system 11 may be easily disassembled for relocation or maintenance. Additionally, the integrity of the inter-tray joint 22 is then not dependent on temperature as adhesive and sealants often have temperature sensitive performance. In other embodiments, the inter-tray joint 22 may include adhesives or sealants. However, the leak-proof (substantial impermeability) quality of the plant growing tray system 11 is not dependent on the adhesives or sealants. For example, in some embodiments, adhesives may provide additional “second line” mechanical support preventing the inter-tray joint 22 from disintegrating, or sealants may provide additional “second line” waterproofing preventing the inter-tray joint 22 from leaking. In other embodiments where the inter-tray joint 22 is above the waterline, the adhesive may substantially provide most or all of the mechanical support, e.g., in such circumstances the interstitial medium 38 may substantially be adhesive.

The modularity of the plant growing tray system 11, according to aspects of this disclosure, aids in maintenance as it allows removal of trays 20 for cleaning, e.g., allowing vertical draining of debris. A plant growing tray system 11 may be exceptionally long and therefore it may not be possible to clean without disassembly.

In some embodiments, such in modular plant growing trays 111 or 211, the plant growing tray system 11 may be configured to be disassembled and reassembled. For example, plants growing on the plant growing tray system 11 may overgrow the plant growing space 32 and require more space. In this scenario, the plant growing tray system 11 may be partially or fully disassembled efficiently by dismantling one or more inter-tray joints to insert one or more additional intermediate trays in-between other trays of the plant growing tray system 11 to achieve an expanded plant growing space. Such a functionality may be provided without reducing an ability of the inter-tray joints to support a tray load.

According to aspects of the present disclosure, a modular plant growing tray 111 may include a plurality of tray modules 120 which may be rapidly assembled together to form the modular plant growing tray 111, e.g., without the need for manual adhesive application or a mandatory curing time. Such an assembly may be performed by an end user or during manufacturing. For example, during manufacturing, the tray 111 may be exposed to additional treatment before or after assembly (e.g., application of adhesives). In some embodiments, the modular plant growing tray 111 may be disassembled and re-assembled multiple times without replacing any components. In some embodiments, depending on the material thickness of the tray module 120, depth of the tray module 120, how much water will be in the tray module 120, how the tray module 120 will be supported underneath, extra hardware may be needed to hold the side wall of the tray module 120 but the same may be true for a tray module 120 with adhesive.

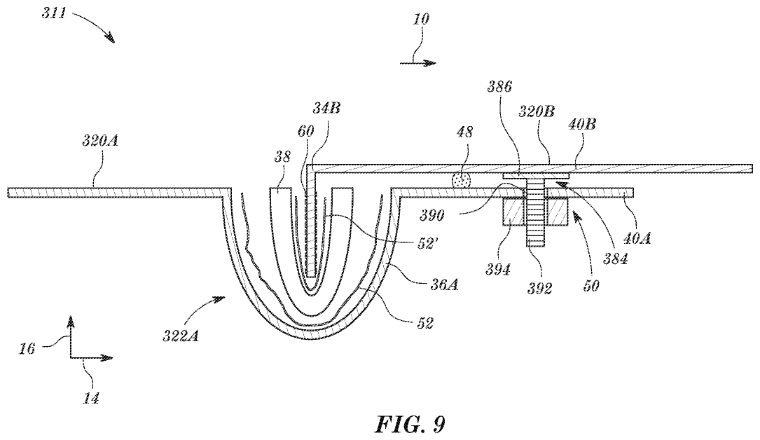

FIG. 9 is an enlarged sectional view taken along cross-section lines A-A′ of FIG. 1A of the plant growing tray system 11 focused on an inter-tray joint, in accordance with some embodiments. The plant growing tray system 311 may include attachment means 50 to irremovably attach the first tray 320B to the second 320A. The inter-tray joint 322A is configured to attach the overlap section 40B of the first tray 320B to the overlap section 40A of the second tray 320A. Attachment means 50 may include an impermeable attachment means, e.g., a waterproof rivet or threadable connections with gaskets. In other embodiments, attachment 50 means may not be impermeable, e.g., they may be positioned above a waterline to prevent water leakage from the tray. The attachment means may comprises a fastener with a head portion 386 fused or attached (e.g., glued or adhesively attached) to an overlap section 40B of the tray 320B. The fastener may include a threaded nut 384, e.g., with a tapped shaft 392. The tapped shaft 392 may be threadably engaged with a complementary bolt 394 positioned proximal to (e.g., underneath) the overlap section 40A of the tray 320A. The bolt 394 comprises an aperture 390 configured to receive the tapped shaft 392. In some embodiments, the tapped shaft 392 may be also fused or attached by other means to the tray 320A.

The first tray 320B and the second tray 320A may be attached via the inter-tray joint 322A. The inter-tray joint 322A may include adhesive 48 attaching an overlap to another overlap. The interstitial medium 38 may include a layer of adhesive 52. The interstitial medium 38 may be attached to the male part 34B, e.g. via a layer of adhesive 52′, or female part 36A.

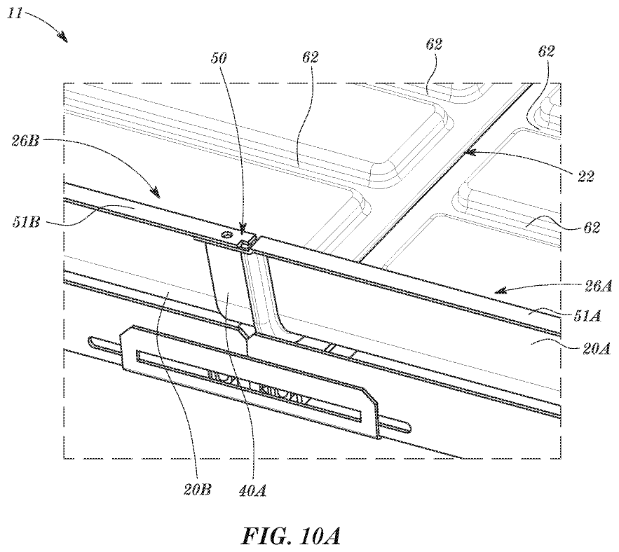

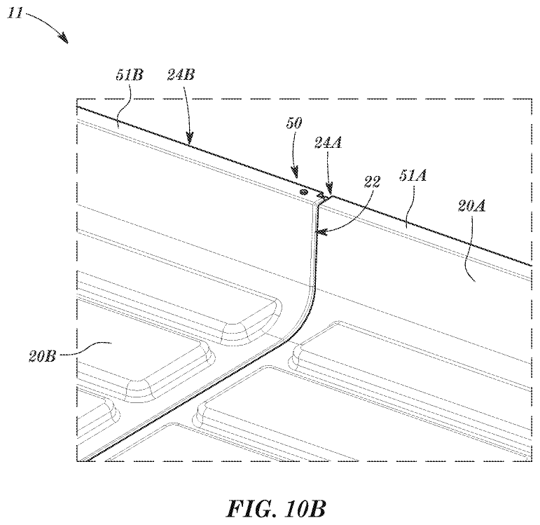

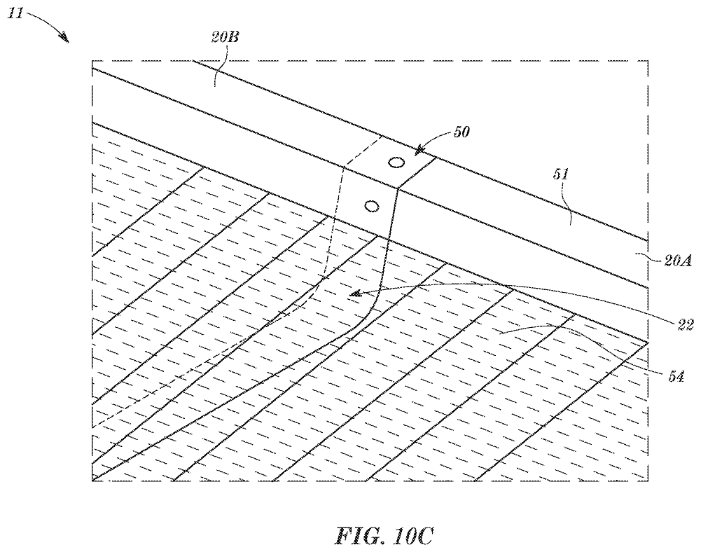

FIG. 10A is a perspective view of a plant growing tray system 11, in accordance with some embodiments.

FIG. 10B is another perspective view of a plant growing tray system 11, in accordance with some embodiments.

FIG. 10C is a schematic perspective view of a plant growing tray system 11, in accordance with some embodiments.

In reference FIGS. 10A-C, flanges 51A-B are provided at each of the lateral ends 24A-B, 26A-B of the respective trays 20A-B. The lateral ends 24A-B, 26A-B may be configured to be above a waterline 54 above which there may substantially be no water or moisture. In some embodiments, the flanges 51A-B are provided elsewhere, e.g., not at or not completely at the lateral ends 24A-B, 26A-B. In some embodiments, soil for growing plants may not substantially extend beyond the waterline 54.

The flanges 51A-B may be provided at lateral ends 24A-B or lateral ends 26A-B, or both lateral ends 24A-B, 26A-B. The flanges 51A-B may be substantially continuous with the rest of the respective trays 20A-B, e.g., the flanges 51A-B may be substantially smoothly connected with the respective trays 20A-B. The flanges 51A-B may be constructed of material configured to withstand loading (i.e., not substantially break, crack, yield, or otherwise materially deform, e.g., to prevent continued loading), e.g., a tray load that may be placed on the tray 11.

In some embodiments, the flanges 51A-B may extend horizontally outwards from the lateral ends 24A-B, 26A-B. The flanges 51A-B may be positioned outside of the plant growing space 32. In some embodiments, the flanges 51A-B may extend not horizontally, but at an angle between horizontal 14 and vertical 16. In some embodiments, flanges 51A-B may be curved and include one or more clasps or clasping structures configured to cause one flange 51A (or 51B) to clasp onto another flange 51B (or 51A, respectively).

In some embodiments, the flanges 51A-B may be integral with the tray. For example, in some embodiments, the trays 20A-B may be manufactured using plastic injection molding via molds comprising hollowed-out blocks configured to receive plastic melt (or other compliant plastic material), wherein the appropriate flanges or other structures may be formed by filling in hollow sections within the mold contiguous with other (remaining) hollow sections of the mold. In some embodiments, the flanges 51A-B may be added to the trays 20A-B as separate components.

The overlap section 40A may extend (or form an extension to the tray 20A) longitudinally underneath the (second) tray 20B, e.g., beyond the horizontal longitudinal end 30B of the tray 20A. The overlap 40A may extend laterally from the first lateral end 24A to the second lateral end 26A. In some embodiments, overlap 40A may provide a substantially continuous support of the plant growing tray system 11 and/or the inter-tray joint 22. The overlap 40A may be configured to attach to an overlap section 40B on the tray 20B. In some embodiments, the first horizontal longitudinal end 30B of the second tray 20A may be positioned at an extremity of the second tray 20A, e.g., if there was no overlap 40A section.

In some embodiments, attachment means 50 may be provided to add additional strength to the inter-tray joint 22A by attaching the trays 20A-B to each other via the flanges 51A-B (or via a flange of one tray connecting to a portion of another tray). Additional “hardware”, e.g., attachment means 50 or other means for attaching, clasping, joining or providing support or a mechanical connection between trays, may be provided in the flange 51, e.g., to provide additional support to the plant growing tray system 11. The attachment means 50 need not be a waterproof, leak-proof, or include a substantially impermeable membrane (gasket) as the flanges 51A-B may be positioned above the waterline 54. In some embodiments, a piercing attachment means 50 may be provided above the waterline 54 to further augment a load carrying capacity of the plant growing tray system 11, e.g., by providing a frictionally engaged connection.

As shown in FIGS. 10A-C, in some embodiments, the attachment means 50 may comprise an opening, e.g., a hole, configured to receive an attachment mechanism to join the flanges 51A-C. The use of an attachment mechanism 50 (integral to the tray or not) to attach one tray to another such as attaching the tray 20A to the tray 20B by attaching the flange 51A to the flange 51B may be centred around attachment portions of trays 20A-B. In reference to some embodiments illustrated by FIGS. 10A-C, the attachment portions are on the flanges 51A-B and include the opening. The attachment portion on one tray 20A may be complementary to the attachment portion on another tray 20B to facilitate attachment of the two trays 20A-B via their attachment portions.

In some embodiments, the attachment means 50 may be built-in or integral with trays 20, e.g., in some embodiments the attachment means 50 may comprise: a protrusion on one flange (51A or 51B) forming a male end of a connector, the protrusion complementary to a recess on the other flange (51B or 51A, respectively) forming a female end of the connector. The connector male and female ends may be co-joined or complementarily engaged with each other, in some embodiments along a common axis, to form a substantially rigid connection. In some embodiments, a gasket may be disposed between connector male and female ends to provide support and/or to make the rigid connection leak (or water) proof, e.g., as a precautionary measure. In some embodiments, an outer circumference of the connector male end may be larger than an inner circumference of the connector female end to cause a material deformation of either or both the connector male and female ends when co-joined or complementarily engaged with each other. The material deformation may retain the male connecter end within the female connector end. Such attachments means 50 may not (e.g., directly) affect or otherwise influence the ability of the tray 11 to prevent leakage (including via the inter-tray joint 22) but may be configured to augment an ability of the inter-tray joint 22 to support the tray 11, e.g., support the tray load or prevent the assembly from disassembling.

Embodiments illustrated by FIGS. 10A-10C were described above in reference to both flanges 51A-B. However, it is understood that in some embodiments, the flange 51A of the tray 20A may be distinct or different than the flange 51B of the tray 20B. In some embodiments, the flanges 51A-B may be designed independently of each, i.e., without reference to a shape or design of the or one or more other flanges, except in an attachment portion of each flange 51A-B. The attachment portion of one flange 51A (or 51B) may be configured to be complementary to the attachment portion of another flange 51B (or 51A, respectively), e.g., to allow an attachment means 50 to connect the two trays. Such attachment means 50 may facilitate the tray 11 to support a tray load.

In reference to some embodiments illustrated by FIGS. 10A-C, flanges 51A-B are the same or substantially the same at the lateral ends 24A-B and the lateral end 26A-B. In some embodiments, flanges 51A-B provided at the lateral ends 24A-B may be distinct from flanges provided at different, separate lateral ends (e.g., lateral ends 26A-B).

Flanges, such as the flanges 51A-B, may be provided with other trays (e.g. 24C-D) at one or more lateral ends (24C-D or 26C-D). A plurality of flanges may thus be provided in the tray 11. The plurality of flanges may comprise a plurality of attachment means (e.g., integral with the tray 11 or modules 20 of the tray) to attach one or more trays to one or more other trays. Such inter-tray attachments may provide the tray 11 with additional load carrying capacity (e.g., to carry a tray load or withstand shocks or prevent disassembly upon movement or vibration or loading) without affecting or influencing (e.g., directly) the ability of the tray 11 to prevent leaks via inter-tray joints 22.

While the discussion above in reference to FIGS. 10A-C describes flanges 51A-B facilitating attachment means 50 to attach one tray to another, e.g., to support a tray load, in some embodiments, attachment means 50 may be provided to connect a tray to another tray without flanges and with or without additional structures. As with some embodiments illustrated by FIGS. 10A-C, such attachment means need not be leakproof attachment means, e.g., permeable enough (materially permeable or via gaps allowing water to leak) without affecting or influencing (e.g., directly) the ability of the tray 11 to prevent leaks via inter-tray joints 22. For example, in some embodiments, attachment means may be provided without a flange but above a waterline to make irrelevant the ability of said attachment means to prevent leaks. In some embodiments, attachment means may be provided below a waterline but external to the trays, e.g., via tabs extending from externals walls of the trays and configured to allow attachment of one tray to another (with additional hardware or not).

In some embodiments, a plant growing tray system 11 or modular tray 111 is provided being both leak-proof (preventing leakage from a plant growing space 32) and having the ability to support tray loads (which may be substantial) by forming an assembly of mechanical connections between two trays 20 comprising a first set of mechanical connections and second set of mechanical connections. The first set of mechanical connections is configured to provide leak-proof connections between trays 20 and support the plant growing tray system 11 or modular tray 111 (e.g., preventing disassembly of the tray and/or supporting a tray load)—enabled in some embodiments by use of the interstitial medium 38, strategic placement and extension of the connections, e.g., along an entire length or edge of a plant growing space, to minimize or substantially reduce the number of places (locations) where a leak may be caused, and/or use of additional structures such as an overlap configured to provide support without harming the leak-proof behaviour of the tray. The first set of mechanical connections may include the inter-tray joints 22. The second set of mechanical connections is configured to provide residual support to the tray 11 or 111 (e.g., over and above the support provided by the first set of mechanical connections) but has no influence over the ability of the tray 11 or 111 to prevent or mitigate leaks—enabled in some embodiments by strategic placement or positioning of the second set of mechanical connections, e.g., away from a plant growing space 32 such as above a waterline or external to the trays 20, and/or by augmenting the first set of mechanical connections, e.g., via adhesive. The second set of mechanical connections may include attachment means 50.

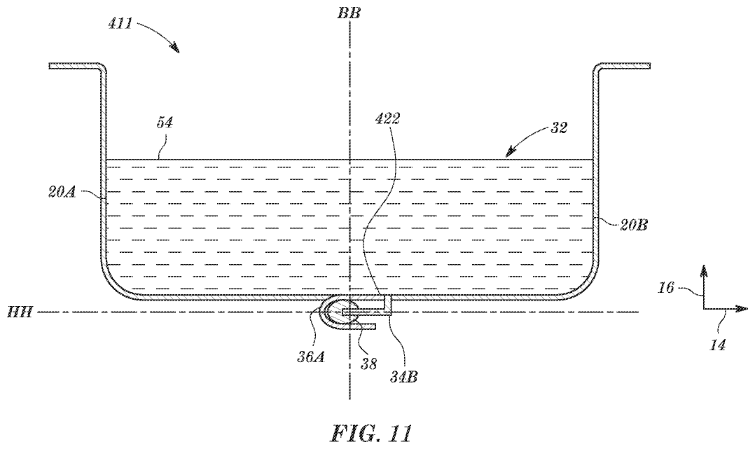

FIG. 11 is a schematic sectional view taken along horizontal longitudinal lines of a plant growing tray system 411, in accordance with some embodiments. The individual parts in FIG. 11 are shown separated (exploded) for illustrative purposes. The inter-tray joint 422A joining trays 20A and 20B may be aligned in a horizontal direction (see dash-dot line HH in FIG. 11), wherein the male and female parts 34B, 36B couple in the horizontal direction 14 with the interstitial medium disposed in-between.

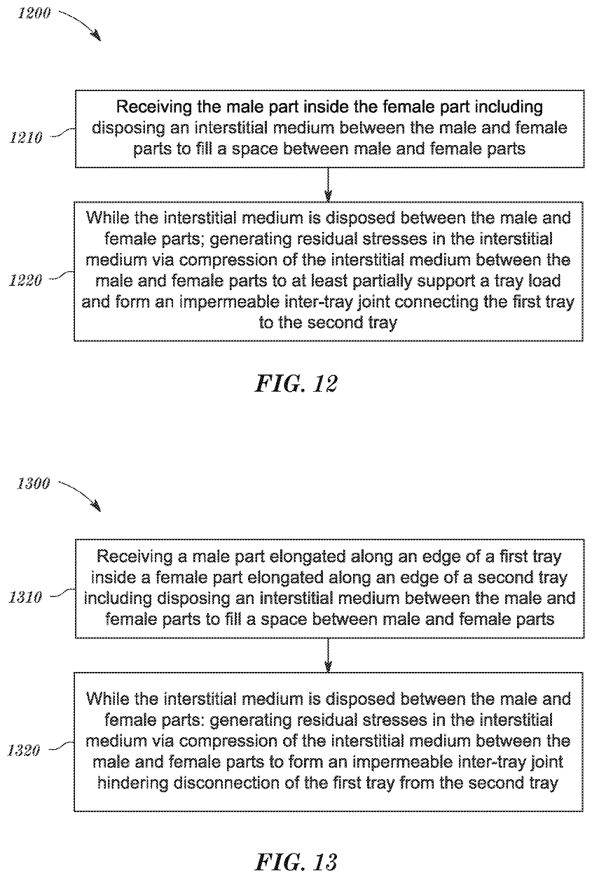

FIG. 12 is a flow chart of a method 1200 of joining a first tray 20B and a second tray 20A of a plant growing tray system 11, in accordance with some embodiments. The method 1200 includes receiving the male part inside the female part including disposing an interstitial medium between the male and female parts to fill a space between male and female parts (step 1210), and while the interstitial medium 38 is disposed between the male and female parts 34B, 36A, generating residual stresses in the interstitial medium 38 via compression of the interstitial medium 38 between the male and female parts 34B, 36A to at least partially support a tray load and form an impermeable inter-tray joint 22A connecting the first tray 20B to the second tray 20A (step 1220).

In various embodiments of the method 1200, steps of the method may be performed in a different order or may be performed at least partially concurrently.

In some embodiments, the interstitial medium between the male and female parts may fill a space between male and female parts by providing a substantially continuous filling from a circumferential surface of the male part (e.g., see circumferential surface 60 on FIG. 9 and interstitial medium in FIG. 4 disposed in between male and female parts) to prevent leakage (of water or other fluid(s)) from the plant growing space 32.

In some embodiments of the method 1200, the first and second trays 20B, 20A are end trays.

In some embodiments of the method 1200, the first tray 20B includes an overlap section 40B longitudinally extending at the longitudinally open end of the first tray 20B, and the second tray 20A includes an overlap section 40A longitudinally extending at the longitudinally open end 44A of the second tray 30A.

Some embodiments of the method 1200 include attaching the overlap section 40B of the first tray 20B to the overlap section 40A of the second tray 20A to support the inter-tray joint 22A.

Some embodiments of the method 1200 include adhesively attaching the first tray 20B to the second tray 20A.

In some embodiments of the method 1200, the interstitial medium 38 is elastomer.

In some embodiments of the method 1200, the inter-tray joint 22A is removable.

In some embodiments of the method 1200, the inter-tray joint 33A extends completely along a perimeter of a cross-section of a plant growing receptacle 32B′ of the first tray 20B, the cross-section parallel to the open end 44B of the plant growing receptacle 32B′ of the first tray 20B.

In some embodiments of the method 1200, the interstitial medium 38 may be substantially impermeable.

FIG. 13 is a flow chart of a method 1300 of forming a substantially continuous or uninterrupted plant growing space 32, in accordance with some embodiments. The method 1300 includes receiving a male part elongated along an edge of a first tray inside a female part elongated along an edge of a second tray including disposing an interstitial medium between the male and female parts to fill a space between male and female parts (step 1310), and while the interstitial medium is disposed between the male and female parts: generating residual stresses in the interstitial medium via compression of the interstitial medium between the male and female parts to form an impermeable inter-tray joint hindering disconnection of the first tray from the second tray (step 1320).

In some embodiments, a tray 20 may be between, approximately, 4″ to 8′ wide from 2 to 20′ long. In some embodiments, tray 20 may be, approximately, 4′, 5′ and 6′ wide and 4 and 8′ long. In some embodiments, the a longitudinal length of a plant growing tray system 11 may be approximately 80′. In some embodiments, the vertical height of each tray 20 may vary from, approximately, 3″ to 6″. In some embodiments, the vertical height may be greater than approximately 12″. In some embodiments, trays 20 may be tray reservoirs (e.g., with a vertical height greater than approximately 1′). In some embodiments, the dimensions of the inter-tray joint 22 and interstitial medium 38 may vary depending on the dimensions and load carrying capacity required of the plant growing tray system 11. In some embodiments, a single type of inter-tray joint 22 may be configured to be used with a variety of standard plant growing tray system 11 dimensions. In some embodiments, the inter-tray joint 22 may have a longitudinal extent of approximately ⅜″ and a vertical extent of approximately ½″. In some embodiments, the inter-tray joint 22 is substantially smaller than the tray 20. In some embodiments, trays 20 may be made of plastic, e.g., acrylonitrile butadiene styrene (ABS), high impact polystyrene (HIPS), polyethylene (PE), or polyvinyl chloride (PVC). In some embodiments, trays 20 may be made of out of aluminum, stainless steel, and steel. In some embodiments, neoprene rubber may be used for the interstitial medium 38.

In some embodiments, the male part may be a first part and the female part may be a second part complementary to the first part. For example, in some embodiments the second part may not include a receptacle having an open end for receiving the first part but may be configured to complementarily couple with the first part, e.g., the first part may comprise teeth configured to couple with slots or features on the second part, or the first part may be a substantially flat extension with a discrete elongated ridge forming a step complementary to a ridge forming a step on the second part. In some embodiments, inter-tray joints may be provided along a plurality of directions. For example, in some embodiments inter-tray joints may be provided along lateral edges of a pair of tray components configured to couple to each other. In some of these embodiments, each of the male and female parts may be elongated along a longitudinal edge of a respective one of the pair of tray components. In some of these embodiments, each of the male and female parts may be elongated between a pair of longitudinal ends of a respective one of the pair of tray components.

In some embodiments, the plant growing space may not be vertically recessed but may be substantially flat or vertically elevated. In some of these embodiments, additional components may be attached to the trays (e.g., to lateral ends of the trays) form a vertically recessed plant growing space. In some of these embodiments, the lateral ends of the trays may not be at substantially different vertical positions relative to the bottom of the trays and/or the inter-tray joints. In some of these embodiments, the lateral ends of the trays may be at a lower vertical position relative to the bottom of the trays and/or the inter-tray joints.

In some embodiments, an intermediate tray may have female parts at both longitudinal ends (i.e., each longitudinal end of the intermediate tray having a female part), e.g., to couple with an end tray or another intermediate tray having a male part at a longitudinal end thereof. In some embodiments, an intermediate tray may have male parts at both longitudinal ends (i.e., each longitudinal end of the intermediate tray having a male part), e.g., to couple with an end tray or another intermediate tray having a female part at a longitudinal end thereof. In some embodiments, two trays (intermediate or end trays) may be configured to inter-connect and form an inter-tray joint using two female (or male) parts connecting to each other via a coupler piece, e.g., a coupler piece having two male (or, respectively, female) parts configured to couple with the two female (or, respectively, male) parts of the trays. Such coupling may be via frictional engagement of the one with the other via interstitial media (integral, removably attached, or irremovably attached to one or more of the male and/or female parts) providing stress (or force) facilitating generation of friction to support a tray load and prevent leakage (by forming impermeable inter-tray joints). Such or other inter-tray joints may comprise one or more distinct pieces of interstitial media, male and female pieces, and may yet be considered embodiments according to aspects of the present disclosure, e.g., the inter-tray joint may retain a functionality according to aspects disclosed herein. In a similar or congruous manner, some embodiments may include further couplers coupling to each other to form a chain of couplers connecting to at least one tray at each of two ends of the chain of couplers to, together, form an inter-tray joint between the trays. In some embodiments, such one or more couplers may have the benefit of providing additional support or additional tray load carrying capacity to the plant growing tray system, e.g., may providing a larger connection mechanism and by distributing the tray load across two or more male-female(-interstitial media) connections. In some embodiments, a coupler may comprise other (additional) connection means, e.g. to augment the inter-tray joints ability to support a load or prevent leakage. In some embodiments, additional leak-proofing sealant may be provided or applied anywhere in or near one or more inter-tray joints to provide additional or precautionary measures to prevent fluid leakage. In some embodiments, a circular plant growing tray system may be provided according to aspects of the present disclosure, wherein. In the context of plant tray systems having non-straight (or non-linear) extends in the horizontal direction, “longitudinal end” does not refer to a specific fixed direction (e.g., always perpendicular to a fixed or not lateral direction) but rather a direction along a plant growing tray system is extended by connecting trays via inter-tray joints.

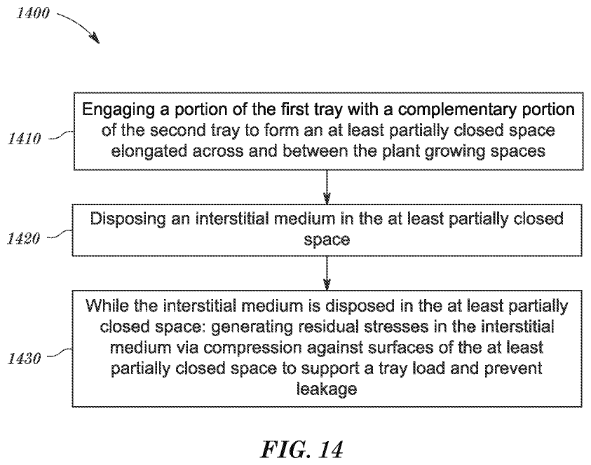

FIG. 14 is a flow chart of a method 1400 of joining a first tray and a second tray, the first tray defining a first plant growing space and the second tray defining a second plant growing space. The method 1400 includes engaging a portion of the first tray with a complementary portion of the second tray to form an at least partially closed space elongated across and between the plant growing spaces (step 1410); disposing an interstitial medium in the at least partially closed space 80 (step 1420); and while the interstitial medium is disposed in the at least partially closed space: generating residual stresses in the interstitial medium via compression against surfaces of the at least partially closed space to support a tray load and prevent leakage (step 1430).

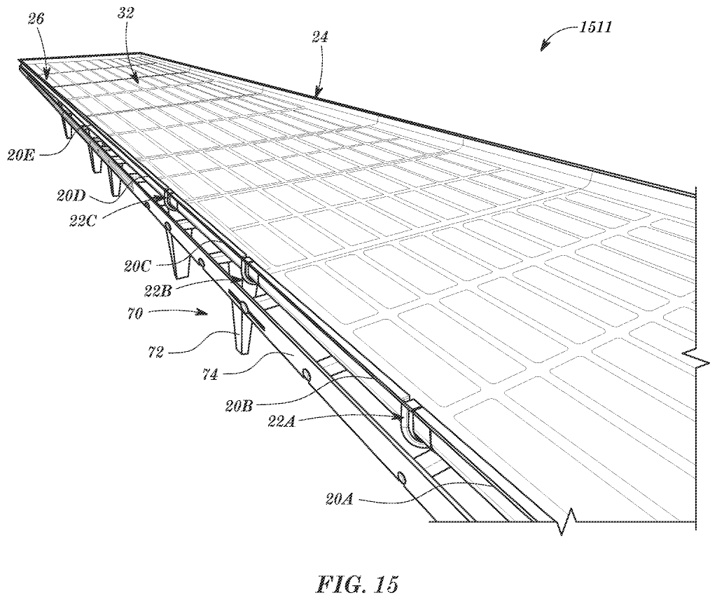

FIG. 15 is a perspective view of a plant growing tray system 1511 atop a support system 70, in accordance with some embodiments.

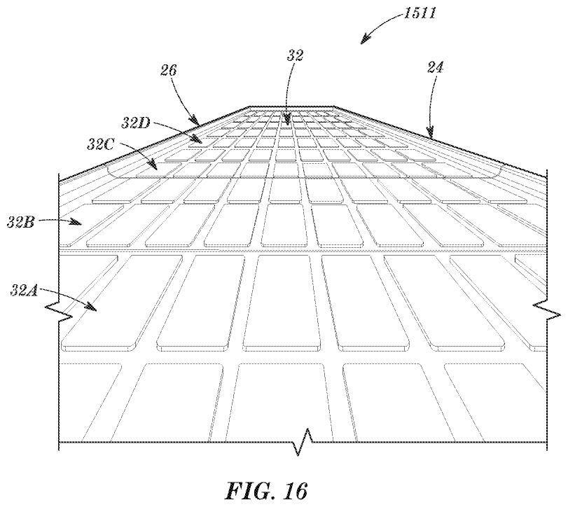

FIG. 16 is another perspective view of the plant growing system 1511 of FIG. 15 atop a support system 70, in accordance with some embodiments.

In reference to FIGS. 15 and 16, the plant growing tray system 1511 comprises a plurality of trays 20A-E interconnected via inter-tray joints, e.g., inter-tray joints 22A-C. A substantially continuous or uninterrupted plant growing space 32 is formed as a result of the interconnection of the plurality of trays 20A-E. Such a continuous or uninterrupted spaces may ridges, e.g., irrigation channels formed therein. By “continuous” or “uninterrupted”, it is not meant that the plant growing space 32 is free of any obstruction but rather that the interconnection does not introduce discontinuities, breaks, spaces, ridges, recessed portions, protrusions or any other large features breaking the contiguity of the plant growing space that would not appear but for the interconnection. The interconnections, however, may still introduce small features into the plant growing tray system.

The plant growing tray system 1511 may be held on a frame 74, attached to legs 72. The legs 72 and frame 74 may be part of a support system 70 of the plant growing tray system 1511.

A first tray 20A defining a first plant growing space 32A extending between at least two ends 24, 26 (or 24A, 26A). Similarly, a second tray 20B defines a second plant growing space 32B extending between at least two ends 24, 26 (or 24B, 26B). An impermeable joint 22A connects the first and second trays 20A, 20B via a compressed medium 38 elongated between the ends 24, 26 (or 24A-B, 26A-B for each of the trays) of the first and second plant growing spaces 32A-B, the compressed medium 38 configured to generate residual stresses to support a tray load (not shown). The joint 22A may be configured to join the first and second plant growing spaces 32A-B to form a continuous or uninterrupted plant growing space. The compressed medium 38 may be configured to prevent leakage from the plant growing tray system 1511.

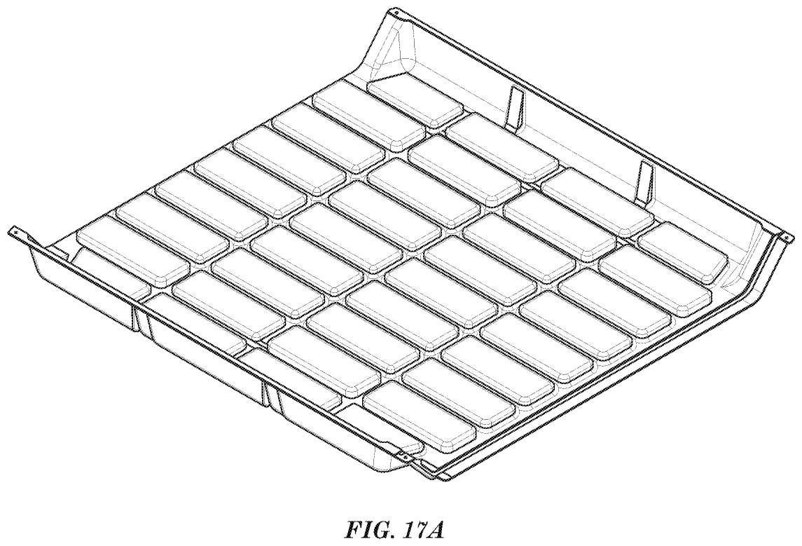

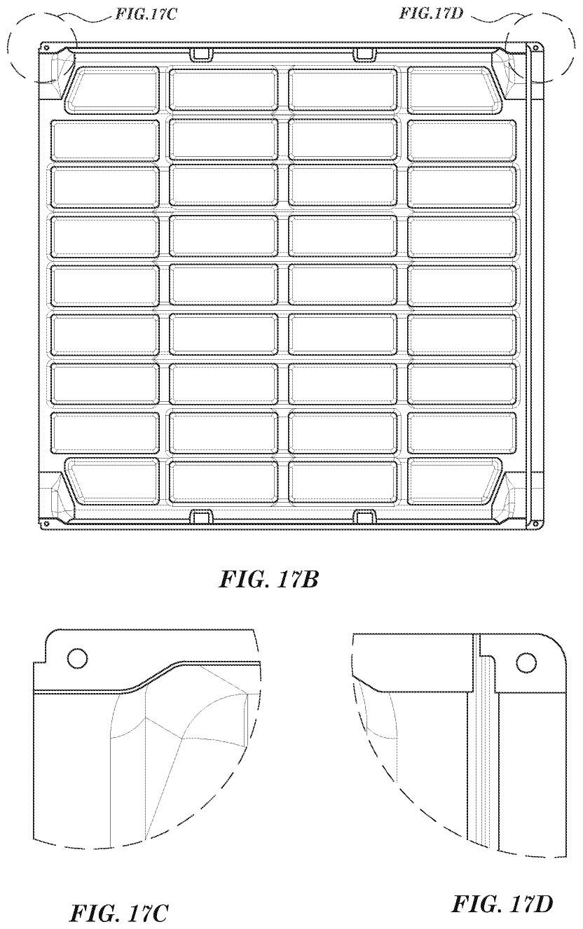

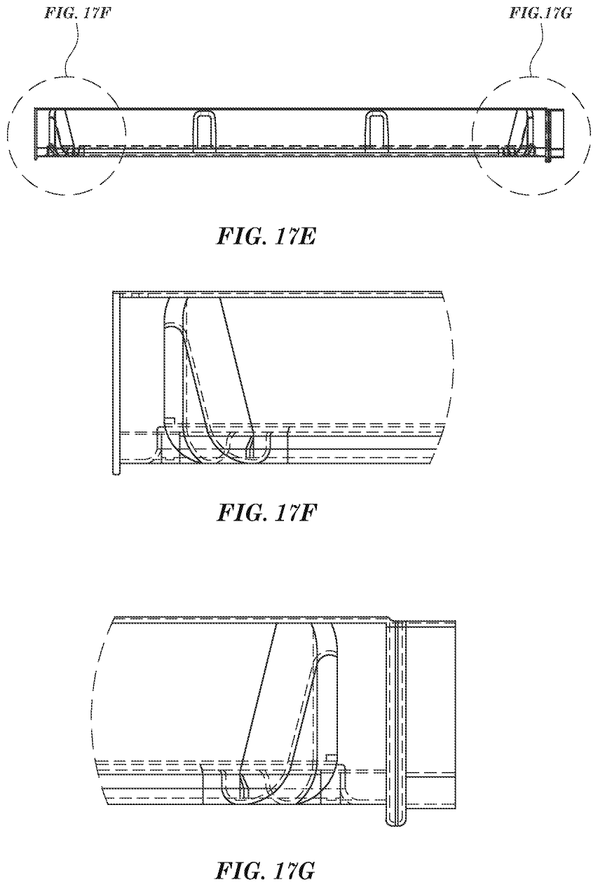

FIGS. 17A to 17G illustrate an example of an intermediary plant growing tray 1700, in accordance with some embodiments. This example illustrates an approximately 4′ by 4′ tray. It should be understood that other dimensions for the sizes of trays may be added, for example, an 8′ by 4′ tray, or a 5′ by 8′. Additionally, different patterns of blocks (e.g., shape, size and configurations) may be provided. In some embodiments, the larger the tray, the more columns and rows of blocks.

FIG. 17A is a perspective view of the intermediary tray 1700. An increased flange size at the corners allows for more space for push rivets and add strength to that location. A gusset may be added to the side wall to increase rigidity and assist with providing an improved seal between a gasket and the tray itself. In some embodiments, blocks with no draft pattern may be added to provide spacing for stacking so no foam spacers are required.

FIG. 17B is a top plan view of the intermediary tray 1700. FIG. 17C is an enlarged view focused on a region of FIG. 17B. FIG. 17D is an enlarged view focused on a region of FIG. 17B. In some embodiments, drafts are added to the corners of the intermediary tray 1700 which improves stackability of the trays during storage and transportation, and increases rigidity in the corners and join location when assembled. The shape of blocks near the corner may be modified to allow more room for increased flange sizes and drafts. Additional support may be added to the lateral ends based on the length of the lateral ends.

FIG. 17E is a side elevation view of the tray 1700. FIG. 17F is an enlarged view focused on a region of FIG. 17E. FIG. 17G is an enlarged view focused on a region of FIG. 17F.

In some embodiments, a plant growing tray system comprises a plurality of trays, including: a first end tray, and a second end tray. Each of the plurality of trays has a first lateral end and a second lateral end, extends between the first and second lateral ends, and has a portion between the first and second lateral ends vertically recessed relative to first and second lateral ends to form a plant growing space. A plurality of inter-tray joints are configured to sequentially connect the plurality of trays to each other. Each inter-tray joint includes a male part positioned at a first horizontal longitudinal end of a tray and elongated between the first and second lateral ends of the tray, a female part complementary to the male part, the female part positioned at a second horizontal longitudinal end of an adjacent tray and elongated between the first and second lateral ends of the adjacent tray, and a substantially impermeable interstitial medium configured to be compressed between the male and female parts to generate residual stresses to at least partially support a tray load and form a substantially impermeable inter-tray joint connecting the tray to the adjacent tray. Each of the first and second end trays is configured to be connected to one of the plurality of trays.

In some embodiments, the plurality of trays include one or more intermediate trays, wherein each intermediate tray is configured to be sequentially connected to two of the plurality of trays.

In some embodiments, each male part is integral to a tray, each female part is integral to a tray, and each intermediate tray has both a male and female part.

In some embodiments, the inter-tray joints are configured to sequentially connect the plant growing spaces of the plurality of trays form a substantially continuous plant growing space.

In some embodiments, an intermediate tray module for a modular plant growing tray is provided. The modular plant growing tray includes a plurality of tray modules configured to sequentially connect to each other via a plurality of inter-module joints. Each of the plurality of tray modules extends between first and second lateral ends and has a portion between the first and second lateral ends vertically recessed relative to first and second lateral ends to form a plant growing space. The plurality of tray modules include a first end module tray and a second end module tray. The intermediate tray module comprises a first horizontal lateral end, a second horizontal lateral end, a first horizontal longitudinal end, a second horizontal longitudinal end, a male part positioned at the first horizontal longitudinal end and elongated between the first and second lateral ends, and a female part positioned at the second horizontal longitudinal end and elongated between the first and second lateral ends. The male part is configured to complementarily engage with a female part of one of the plurality of tray modules via a first substantially impermeable interstitial medium. The female part is configured to complementarily engage with a male part of one of the plurality of tray modules via a second substantially impermeable interstitial medium. The intermediate tray module extends between the first and second lateral ends. A portion of the intermediate tray module between the first and second lateral ends is vertically recessed relative to first and second lateral ends to form a plant growing space of the intermediate tray module. The first interstitial medium is configured to be compressed to form a first substantially impermeable inter-tray joint, and the second interstitial medium is configured to be compressed to form a second substantially impermeable inter-module joint. The first and second inter-module joints are configured to at least partially support a tray load.

In some embodiments, the intermediate tray module includes the first interstitial medium.

In some embodiments, the intermediate tray module includes the second interstitial medium.

In some embodiments, a method of joining a first tray and a second tray of a plant growing tray system is provided. The first and second trays each have a plant growing receptacle with a longitudinally open end. The first tray includes a male part laterally elongated along an edge of the open end of the plant growing receptacle of the first tray. The second tray includes a female part laterally elongated along an edge of the open end of the plant growing receptacle of the second tray. The plant growing receptacle is vertically recessed relative to first and second lateral ends. The method comprises receiving the male part inside the female part including disposing an interstitial medium between the male and female parts to fill a space between male and female parts, and while the interstitial medium is disposed between the male and female parts: generating residual stresses in the interstitial medium via compression of the interstitial medium between the male and female parts to at least partially support a tray load and form an impermeable inter-tray joint connecting the first tray to the second tray.

In some embodiments, the first and second trays are end trays.

In some embodiments, the first tray includes an overlap section longitudinally extending at the longitudinally open end of the first tray, and the second tray includes an overlap section longitudinally extending at the longitudinally open end of the second tray. The method includes attaching the overlap section of the first tray to the overlap section of the second tray to support the inter-tray joint.

In some embodiments, the method includes adhesively attaching the first tray to the second tray.

In some embodiments, the interstitial medium is elastomer.

In some embodiments, the inter-tray joint is removable.

In some embodiments, the inter-tray joint extends completely along a perimeter of a cross-section of the plant growing receptacle of the first tray, and the cross-section is parallel to the open end of the plant growing receptacle of the first tray.

In some embodiments, the interstitial medium is substantially impermeable.

In some embodiments, a method of forming a substantially continuous plant growing space is provided. The method comprises receiving a male part elongated along an edge of a first tray inside a female part elongated along an edge of a second tray including disposing an interstitial medium between the male and female parts to fill a space between male and female parts, and while the interstitial medium is disposed between the male and female parts: generating residual stresses in the interstitial medium via compression of the interstitial medium between the male and female parts to form an impermeable inter-tray joint hindering disconnection of the first tray from the second tray.

In some embodiments, a plant growing tray system comprises a first tray defining a first plant growing space extending between at least two ends, a second tray defining a second plant growing space extending between at least two ends, and an impermeable joint connecting the first and second trays via a compressed medium elongated between the ends of the first and second plant growing spaces. The compressed medium is configured to generate residual stresses to support a tray load.

In some embodiments, the joint is configured to join the first and second plant growing spaces to form an uninterrupted plant growing space.

In some embodiments, the compressed medium is configured to mitigate leakage from the plant growing tray system.

In some embodiments, a method of joining a first tray and a second tray is provided where the first tray defines a first plant growing space and the second tray defines a second plant growing space. The method comprises engaging a portion of the first tray with a complementary portion of the second tray to form an at least partially closed space elongated across and between the plant growing spaces, disposing an interstitial medium in the at least partially closed space, and while the interstitial medium is disposed in the at least partially closed space: generating residual stresses in the interstitial medium via compression against surfaces of the at least partially closed space to support a tray load and mitigate leakage.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, inter-tray joints may include multiple male and female parts, or plant growing tray system may have a non-parallel sections, inter-tray joints may include any combination of any one or more of adhesives, sealants, and gaskets (e.g., elastomeric gaskets), one or more trays may have distinct/different inter-tray joints, an intermediate tray may be configured to have one type (embodiment) of inter-tray joint on one longitudinal end and another type (embodiment) of inter-tray joint on another longitudinal end, differing types of inter-tray joints (e.g., on different longitudinal ends of the same tray) may be used to direct (or inform) assembly of a plant growing tray system, and/or inter-tray joints may be provided in more than one direction (e.g., lateral and/or longitudinal). Yet further modifications could be implemented by a person of ordinary skill in the art in view of the present disclosure, which modifications would be within the scope of the present technology.

The discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A plant growing tray system, comprising:
a first tray including:
a first horizontal lateral end;
a second horizontal lateral end;
a first horizontal longitudinal end; and
a male part positioned at the first horizontal longitudinal end and elongated between the first and second lateral ends;
wherein the first tray extends between the first and second lateral ends, a portion between the first and second lateral ends of the first tray being vertically recessed to form a first plant growing space;
a second tray including:
a third horizontal lateral end;
a fourth horizontal lateral end;
a second horizontal longitudinal end; and
a female part positioned at the second horizontal longitudinal end and elongated between the third and fourth lateral ends, the female part configured to complementarily couple with the male part;
wherein the second tray extends between the third and fourth lateral ends, a portion between the third and fourth lateral ends of the second tray being vertically recessed to form a second plant growing space; and
a substantially impermeable interstitial medium configured to at least partially extend around a circumferential surface of the male part to fill a space between male and female parts;
wherein the interstitial medium is configured to be compressed between the male and female parts to generate residual stresses to at least partially support a tray load and form a substantially impermeable inter-tray joint connecting the first tray to the second tray.

2. The plant growing tray system as claimed in claim 1, wherein the inter-tray joint is configured to connect the first plant growing space to the second plant growing space to form a substantially continuous plant growing space.

3. The plant growing tray system as claimed in claim 1, wherein:
the first horizontal longitudinal end of the first tray is positioned at an extremity of the first tray; and
the second horizontal longitudinal end of the second tray is positioned at an extremity of the second tray.

4. The plant growing tray system as claimed in claim 1, wherein:
the first and second lateral ends of the first tray are positioned at extremities of the first tray; and
the third and fourth lateral ends of the second tray are positioned at extremities of the second tray.

5. The plant growing tray system as claimed in claim 1, wherein the inter-tray joint includes an adhesive.

6. The plant growing tray system as claimed in claim 1, wherein:
the first tray includes a first overlap section extending horizontal longitudinally at the first horizontal longitudinal end of the first tray; and
the second tray includes a second overlap section extending horizontal longitudinally at the second horizontal longitudinal end of the second tray;
wherein the inter-tray joint is configured to attach the first overlap section of the first tray to the second overlap section of the second tray.

7. The plant growing tray system as claimed in claim 1, wherein at least one of:
the male and female parts are configured to connect along a vertical direction and prevent the inter-tray joint from protruding into a plant growing space of the system; or
the male part extends vertically below the first plant growing space and the female part extends vertically below the second plant growing space.

8. The plant growing tray system as claimed in claim 1, wherein at least one of:
the interstitial medium is an elastomer;
the interstitial medium includes silicone; or
the interstitial medium includes a layer of adhesive.

9. The plant growing tray system as claimed in claim 8, wherein the elastomer is neoprene.

10. The plant growing tray system as claimed in claim 1, wherein the male part is an integral part of the first tray and the female part is an integral part of the second tray.

11. The plant growing tray system as claimed in claim 1, wherein the second tray is configured to be removably connected to the first tray via the inter-tray joint.

12. The plant growing tray system as claimed in claim 1, wherein the interstitial medium is one of:
attached to the male part; or
removably attached to the male part.

13. The plant growing tray system as claimed in claim 1, wherein the first and second trays are end trays of the tray system.

14. The plant growing tray system as claimed in claim 17, wherein each end tray of the tray system includes a sidewall defining a closed longitudinal end of the respective end tray.

15. The plant growing tray system as claimed in claim 1, wherein the first and second trays include an end tray and an intermediate tray of the tray system, the plant growing tray system including:
an additional end tray configured to be connected to the intermediate tray via an additional inter-tray joint.

16. The plant growing tray system as claimed in claim 1, wherein the first and second trays include an end tray and an intermediate tray of the tray system, the plant growing tray system including:
a plurality of additional intermediate trays sequentially connected via a plurality of intermediate inter-tray joints, the second tray configured to be connected to a first longitudinal end of the plurality of additional intermediate trays via a second inter-tray joint, and
an additional end tray configured to be connected to a second longitudinal end of the plurality of additional intermediate trays via an additional inter-tray joint.

17. The plant growing tray system as claimed in claim 1, wherein the interstitial medium surrounds the male part.

18. The plant growing tray system as claimed in claim 1, wherein the male part continuously extends between the first and second lateral ends of the first tray and the female part continuously extends between the third and fourth lateral ends of the second tray.

19. The plant growing tray system as claimed in claim 1, wherein the inter-tray joint is configured to be positioned outside of the first and second plant growing spaces to form a substantially continuous plant growing space by connecting the first plant growing space to the second plant growing space.

20. The plant growing tray system as claimed in claim 1, wherein the male part is positioned vertically below the first plant growing space and the female part is positioned vertically below the second plant growing space.
